(19) United States
(12) Patent Application Publication
(10) Pub. No.: US 2015/0152295 A1
(43) Pub. Date: Jun. 4, 2015

(54) ANTISTATIC RELEASE FILM

(71) Applicant: DEXERIALS CORPORATION, Tokyo (JP)

(72) Inventor: Minoru Nagashima, Utsunomiya-shi (JP)

(21) Appl. No.: 14/412,248

(22) PCT Filed: Jul. 25, 2013
(86) PCT No.: PCT/JP2013/070152

§ 371 Date: Dec. 31, 2014

(30) Foreign Application Priority Data
Jul. 25, 2012 (JP) 2012-164389

(51) Int. Cl. C09J 7/02

(52) U.S. Cl. CPC C09J 7/0228; C09J 2467/001; C09J 2483/005

(57) ABSTRACT

In an antistatic release film including an antistatic layer formed on at least one side of a substrate film and a silicone-based release layer formed on the antistatic layer, the antistatic layer contains a component (a) of a condensation reaction product obtained by a condensation reaction of a hydrolysate of an alkyl silicate with a coupling agent, a component (b) of a water-soluble resin for film formation, and a component (c) of an antistatic agent. The alkyl silicate has a structure represented by the formula (1) and the coupling agent has a structure represented by the formula (2).

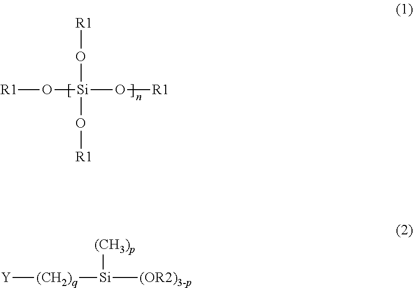

### TECHNICAL FIELD

The present invention relates to an antistatic release film that has an antistatic layer formed on one side of a substrate film and a silicone-based release layer formed on the antistatic layer.

### BACKGROUND ART

In order to prevent a foreign substance from attaching to an anisotropic conductive film (ACF) and handleability from decreasing due to electrification, a release film used for the ACF and the like is required to exhibit not only favorable releasability but also favorable antistatic properties. As such a release film, a release film has been proposed in which an antistatic layer containing a reactant of isocyanate with alkyl acetylene diol generally used as a surfactant and a conductive macromolecule as an antistatic agent is provided on a substrate film such as a polyester film and a silicone-based release layer is provided on the antistatic layer (Patent Literature 1).

### CITATION LIST

### Patent Literature

Patent Literature 1: Japanese Patent Application Laid-Open No. 2007-83536

### SUMMARY OF INVENTION

### Technical Problem

However, in the antistatic release film proposed in Patent Literature 1, since alkyl acetylene diol in the antistatic layer serves as a surfactant, there arises a problem in which adhesion between the antistatic layer and the silicone-based release layer is decreased. This problem tends to markedly arise when the antistatic release film is left under a high temperature and high humidity environment for an extended period of time. When an ACF is layered on the antistatic release film, the silicone-based release layer may be transferred and attached to the ACF, so that characteristics of the ACF are prevented from being exerted.

An object of the present invention is to solve the conventional problems. Further, in an antistatic release film that has an antistatic layer formed on one side of a substrate film and a silicone-based release layer formed on the antistatic layer, an object is to allow adhesion between the antistatic layer and the silicone-based release layer to achieve a favorable level even when the film is left under a high temperature and high humidity environment while a release force and a surface resistivity to be satisfied are exhibited.

### Solution to Problem

The present inventor has found that, when an antistatic layer contains a condensation reaction product obtained by a condensation reaction of a hydrolysate of an alkyl silicate with a coupling agent, a water-soluble resin for film formation, and an antistatic agent, the object can be achieved. Thus, the present invention has been completed.

Specifically, the present invention provides an antistatic release film that has an antistatic layer formed on one side of a substrate film and a silicone-based release layer formed on the antistatic layer, wherein the antistatic layer contains the following components (a) to (c):

(a) a condensation reaction product obtained by a condensation reaction of a hydrolysate of an alkyl silicate with a coupling agent;
(b) a water-soluble resin for film formation; and
(c) an antistatic agent.

The present invention further provides an adhesive tape with a release film in which a double-sided adhesive film is layered on this antistatic release film.

### Advantageous Effects of Invention

In an antistatic release film of the present invention that has an antistatic layer formed on one side of a substrate film and a silicone-based release layer formed on the antistatic layer, the antistatic layer contains a condensation reaction product obtained by a condensation reaction of a hydrolysate of an alkyl silicate with a coupling agent. For this reason, the antistatic layer is allowed to have favorable adhesion to the substrate film such as a polyester film, and also allowed to have favorable adhesion to the silicone-based release layer even when the film is left under a high temperature and high humidity environment. A water-soluble resin for film formation can be uniformly mixed with the condensation reaction product and an antistatic agent in an aqueous medium, and thus a coating composition for formation of an antistatic layer that has excellent handleability can be provided.

### BRIEF DESCRIPTION OF DRAWINGS

FIG. 1 is a schematic cross-sectional view of an antistatic release film of the present invention.

### DESCRIPTION OF EMBODIMENTS

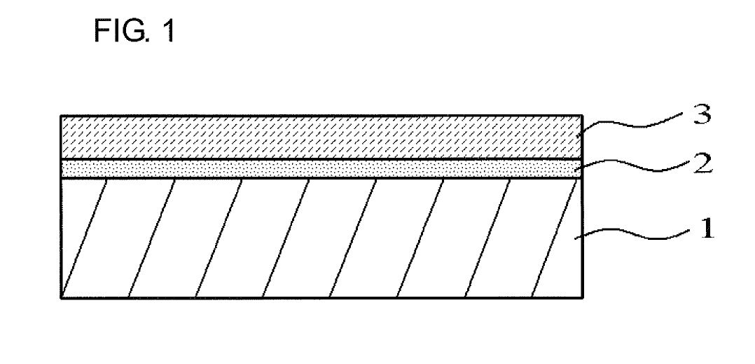

As shown in FIG. 1, an antistatic release film of the present invention has a structure in which an antistatic layer 2 is formed on one side of a substrate film 1 and a silicone-based release layer 3 is formed on the antistatic layer 2.

### <<Substrate Film 1>>

For the substrate film 1, a substrate film that is used in a conventional release film can be used. A polyethylene terephthalate film, a polyamide film, or a polyimide film that usually has a thickness of 10 to 200 μm can be used.

### <<Antistatic Layer 2>>

The antistatic layer 2 is a layer that usually has a thickness of 0.05 to 0.5 μm and contains the following components (a) to (c):

(a) A condensation reaction product obtained by a condensation reaction of a hydrolysate of an alkyl silicate with a coupling agent;

(b) a water-soluble resin for film formation; and

(c) an antistatic agent.

Hereinafter, each of the components will be described in detail.

<Component (a)>

The component (a) is a condensation reaction product obtained by a condensation reaction of a hydrolysate of an alkyl silicate with a coupling agent.

Herein, the alkyl silicate is a silicate ester having an alkoxy group bonded to a silicon atom as a hydrolyzable group that may be hydrolyzed, and is specifically a compound having a structure represented by the formula (1). A commercially available product may be used.

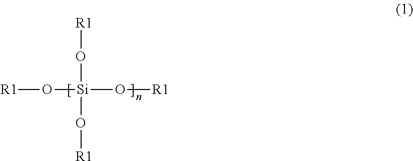

In the formula (1), R1 is an alkyl group, preferably an alkyl group having 1 to 3 carbon atoms in terms of boiling point and reactivity, and particularly preferably a methyl group in terms of high reactivity or an ethyl group in terms of low environmental impact, and n represents a repetition number (degree of polymerization) of the siloxane unit, and is an integer of 1 or more, preferably 3 to 8 in terms of reactivity, and particularly preferably 5.

When such an alkyl silicate is hydrolyzed (i.e., dealcoholized) as shown in the following scheme, it is considered that a dehydration-condensation reaction (formation of macromolecule) or a cracking reaction (formation of low molecule) may be caused to produce a hydrolysate that is two-dimensionally extended. In the following scheme, R1 is as defined in the formula (1).

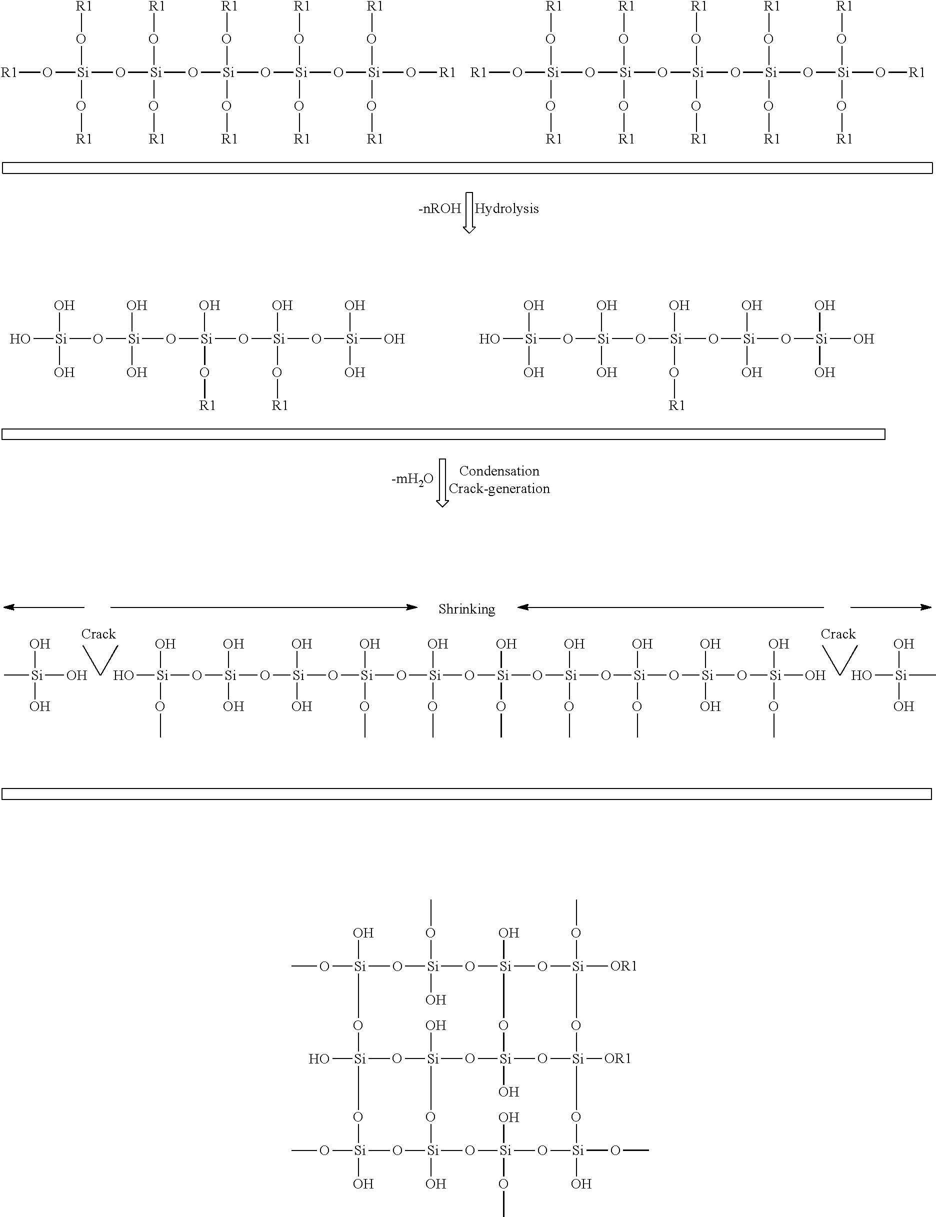

Herein, for hydrolysis of an alkyl silicate, a known procedure can be utilized. For example, an alkyl silicate is dissolved in an excess amount of water or a mixed solvent of water and a water-miscible solvent such as ethanol in the presence of an acid catalyst such as hydrochloric acid or toluene sulfonic acid, and a reaction is caused at a temperature of room temperature to 80° C. Thus, hydrolysis can be performed.

When the number average molecular weight of such a hydrolysate of an alkyl silicate is too small, the film properties tend to be insufficient. When it is too large, the solubility tends to be reduced. Therefore, the number average molecular weight thereof is preferably 200 to 500, and more preferably 300 to 400.

When the degree of hydrolysis of the hydrolysate of an alkyl silicate as described above is too small, the reactivity thereof with a coupling agent is reduced. Therefore, the degree of hydrolysis is preferably such that 50% or more, and more preferably 80% or more of total number of “OR1” groups are hydrolyzed to become hydroxyl groups.

The coupling agent used in a condensation reaction of the hydrolysate of an alkyl silicate as described above is a compound having a hydrolyzable group that may be hydrolyzed to produce a hydroxyl group, such as an alkoxy group, an acyloxy group, and a ketoxymate group, an affinity group for or a reactive group with a surface of an organic substance, and an affinity group for or a reactive group with a surface of an inorganic substance. A known coupling agent, preferably a silane coupling agent, or a titanium coupling agent such as tetraalkoxy titanium can be used. In particular, a silane coupling agent can be preferably used in terms of hydrolyzability. As such a silane coupling agent, a compound represented by the formula (2) can be preferably used.

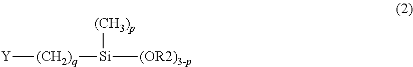

In the formula (2), R2 is an alkyl group having 1 to 3 carbon atoms that may be substituted with an alkoxy group (preferably an alkoxy group having 1 to 3 carbon atoms) or an acyloxy group, Y is a glycidyloxy group, an epoxy group, an amino group, a vinyl group, an allyl group, a (meth)acryloyloxy group, a mercapto group, an isocyanate group, an ureido group, or an alkylthio group having 1 to 3 carbon atoms, p is an integer of 0 to 2, and q is an integer of 0 to 3.

Particularly preferable examples of the silane coupling agent represented by the formula (2) may include a compound wherein R2 is a methyl group, Y is a glycidyloxy group, p is 0, and q is 3.

The condensation reaction product as the component (a) is a product obtained by a condensation reaction of the hydrolysate of an alkyl silicate with the silane coupling agent. When the amount of the coupling agent to be reacted with 100 parts by mass of the hydrolysate of an alkyl silicate (mass basis excluding that of water or a mixed solvent of water and a water-miscible solvent (ethanol, methanol, acetone, etc.) is too small, the reactivity tends to be reduced. When it is too large, the affinity tends to be reduced. Therefore, the amount of coupling agent to be used in the condensation reaction is preferably 100 to 500 parts by mass, and more preferably 200 to 300 parts by mass.

In general, the condensation reaction product as the component (a) is preferably present in a state in which the component (a) in an amount of 0.5 to 5% by mass in terms of theoretical solid content is dissolved in water or a mixed solvent of water or a water-miscible solvent (ethanol, methanol, acetone, etc.).

Examples of a condensation reaction condition may include a condition of stirring at room temperature for 24 hours.

<Component (b)>

The component (b) is a water-soluble resin for film formation. In order to mix the component (b) with the condensation reaction product as the component (a), the component (b) needs to be water soluble. Herein, “water soluble” means a property of at least 10 g of the compound being dissolved in 100 g of water at 20° C. Examples of such a water-soluble resin for film formation may include a polyester resin, a polyvinyl alcohol resin, a carboxy methylol resin, and a polyvinylpyrrolidone resin. In particular, a water-soluble polyester resin, and especially a resin in which an acid component is phthalic acid or a derivative thereof and an alcohol component is ethylene glycol can be preferably used.

<Component (c)>

The component (c) is an antistatic agent. A known antistatic agent can be applied. In particular, a known conductive macromolecule can be preferably applied in terms of surface resistance. Specific preferable examples of the conductive macromolecule may include compounds represented by the following formulae (3) and (4).

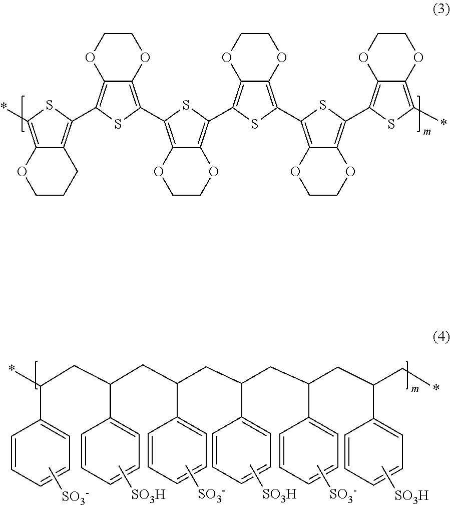

In the formulae (3) and (4), ms represent the number of the repeating unit, and it is preferable that ms be each independently an integer of 20 to 80.

When the content (in terms of theoretical solid content) of the condensation reaction product as the component (a) in the antistatic layer 2 is too small, the adhesion tends to be poor. When it is too large, the film tends to be hard. Therefore, the content thereof is preferably 30 to 80% by mass, and more preferably 45 to 65% by mass.

When the content of the water-soluble resin for film formation as the component (b) in the antistatic layer 2 is too small, the film tends to be hard. When it is too large, the adhesion force tends to be insufficient. Therefore, the content thereof is preferably 5 to 40% by mass, and more preferably 10 to 30% by mass.

When the content of the antistatic agent as the component (c) in the antistatic layer 2 is too small, the antistatic performance tends to be insufficient. When it is too large, the surface resistance tends to be excessively reduced. Therefore, the content thereof is preferably 10 to 40% by mass, and more preferably 20 to 30% by mass.

The content ratio by mass of the condensation reaction product as the component (a) (in terms of theoretical solid content) to the water-soluble resin for film formation as the component (b) in the antistatic layer 2 is preferably 100:200 to 300. When the content ratio of the water-soluble resin for film formation as the component (b) is largely less than this range, the film tends to be hard. In contrast, when it is largely more than the range, the adhesion force tends to be insufficient.

The antistatic layer 2 as described above can be formed as follows. A coupling agent is added to a hydrolysate of an alkyl silicate (water-alcohol solution), and the mixture is stirred to obtain a water-alcohol solution of the condensation reaction product. Then, a water-soluble resin for film formation and an antistatic agent are uniformly mixed in the water-alcohol solution to prepare a composition for formation of an antistatic layer.

The composition is applied to a substrate film 1 by an ordinary method, and dried to form a film.

### <<Silicone-Based Release Layer 3>>

For the silicone-based release layer 3, a silicone-based release layer of a conventional release film can be used. The thickness thereof is generally 0.05 to 0.5 μm. Such a silicone-based release layer can be generally formed by forming a film on the antistatic layer 2 using a known silicone for a release paper through a known procedure. Examples of the known silicone for a release paper may include a condensation-type silicone, such as a silicone obtained by condensation of hydroxy polydimethyl siloxane and hydrogen polydimethyl siloxane, and an addition reaction-type silicone, such as a silicone obtained by an addition reaction of glycidyl polydimethyl siloxane with a curing agent.

The antistatic release film of the present invention can be used as a release film of a known double-sided adhesive film. A double-sided adhesive film is layered on such a release film. A slip sheet is inserted as necessary, and the layered body is wound to obtain an adhesive tape with a release film wound into a roll. As a preferable double-sided adhesive film, an anisotropic conductive film can be used. As the anisotropic conductive film, a known anisotropic conductive film can be adopted.

The antistatic performance of the antistatic release film of the present invention can be appropriately set depending on the purposes of use of the antistatic release film. The surface resistivity is preferably 1×10¹¹Ω/square or less, and more preferably 1×10¹⁰Ω/square or less. When the surface resistivity is too low, the antistatic performance is sufficient, but a problem of decrease in insulating properties may be caused. Therefore, the surface resistivity is preferably 1×10⁶Ω/square or more.

The release performance of the antistatic release film of the present invention can be appropriately set depending on the purposes of use of the antistatic release film, and can be evaluated by the release force of an adhesive film stuck on the silicone-based release layer. For example, an acrylic adhesive film (T4090, Dexerials Corporation) is stuck on the silicone-based release layer at a temperature of 70° C. and a pressure of 25 g/cm², and after 16 hours, the release force is measured by a release testing machine (TENSILON universal material testing instrument, ORIENTEC Co., LTD.). The release strength is preferably 0.6 N/5 cm or less, and more preferably 0.4 N/5 cm or less. When the release force is too low, the release performance is sufficient, but there may be a problem in which it is difficult to hold an adhesive layer on the release layer. Therefore, the release force is preferably 0.05 N/5 cm or more, and more preferably 0.1 N/5 cm or more.

### EXAMPLES

Hereinafter, the present invention will be described specifically by way of Examples.

### Reference Example 1

### Preparation of Partial Hydrolysate of Alkyl Silicate

100 parts by mass of methyl silicate (methyl silicate 51, COLCOAT CO., LTD.) was placed in a reaction vessel equipped with a nitrogen inlet tube, a thermometer, and a stirrer, and 15 parts by mass of ethanol and 0.01% by mass of sulfuric acid were then added thereto. After completion of addition, the mixture was continuously stirred for 1 hour. After completion of stirring, methanol produced by hydrolysis and added ethanol were distilled away from the reaction product using an evaporator. The resulting distilled residue was allowed to pass through a cation exchange resin column to remove excess sulfuric acid. While 100 parts by mass of isopropyl alcohol was added in small portions to the obtained partial hydrolysate, the mixture was continuously stirred for 10 hours. As a result, a partial hydrolysate of methyl silicate having a number average molecular weight of 350 was obtained as an isopropyl alcohol solution.

### Reference Example 2

### Preparation of Condensation Reaction Product

25 parts by mass (theoretical solid content: 2% by mass) of the solution of the partial hydrolysate of methyl silicate in isopropyl alcohol, which was prepared in Reference Example 1, was placed in a reaction vessel equipped with a stirrer. 5 parts by mass of a silane coupling agent (A-187, Momentive Performance Materials Inc.) was gradually added under stirring to obtain a condensation reaction product as an isopropyl alcohol solution.

### Reference Example 3

### Preparation of Water-Soluble Polyester Resin

40 parts by mass of terephthalic acid, 40 parts by mass of isophthalic acid, 150 parts by mass of ethylene glycol, and 10 parts by mass of zinc acetate were placed in a reaction vessel equipped with a Dean-Stark device, a nitrogen inlet tube, a thermometer, and a stirrer, and the temperature thereof was increased to 210° C. with stirring. While water produced by esterification was azeotropically removed, a dehydration-condensation reaction was caused. When the amount of water actually distilled reached 75% of a theoretical total distillation amount, 10 parts by mass of 5-sodiosulfoisophthalic acid was added to the reaction vessel. The dehydration-condensation reaction was further continued to obtain a water-soluble polyester resin with a glass transition temperature Tg of 68° C.

### Example 1

### Preparation of Composition for Formation of Antistatic Layer

In a reaction vessel, 11 parts by mass of ion-exchanged water and 1 part by mass of the water-soluble polyester resin of Reference Example 3 were mixed with stirring, and 26 parts by mass of ethanol was further added. The mixture was uniformly stirred. To the mixture, 20 parts by mass of antistatic agent (polyethylene dioxythiophene-polystyrene sulfonate; clevios P, H. C. Starck GmbH) was added, and the mixture was uniformly stirred. To the mixture, 42 parts by mass of the solution of the condensation reaction product in isopropyl alcohol of Reference Example 2 was added, and the mixture was uniformly stirred to obtain a composition for formation of an antistatic layer.

### (Preparation of Composition for Formation of Silicone-Based Release Layer)

In a reaction vessel, 10 parts by mass of a curable silicone solution (KS847, Shin-Etsu Chemical Co., Ltd.), 0.1 parts by mass of a platinum-based curing agent (CAT-PL50T, Shin-Etsu Chemical Co., Ltd.), and 90 parts by mass of toluene were mixed with stirring to obtain a composition for formation of a silicone-based release layer.

### (Formation of Antistatic Release Film)

The composition for formation of an antistatic layer was applied to one side of a polyester substrate film with a thickness of 50 μm (Tetron U2, TEIJIN LIMITED) so as to have a dried thickness of 0.1 μm, and dried at 160° C. for 1 minute to form an antistatic layer.

The composition for formation of a silicone-based release layer was applied to the antistatic layer so as to have a dried thickness of 0.3 μm, and dried at 160° C. for 1 minute to form a silicone-based release layer. Thus, an antistatic release film was obtained.

### Example 2

An antistatic release film was produced in the same manner as in Example 1 except that another curable silicone solution (LTCF750A, SRX212, Dow Corning Toray Co., Ltd.) was used instead of the curable silicone solution (KS847, Shin-Etsu Chemical Co., Ltd.).

### Comparative Example 1

An antistatic release film was produced in the same manner as in Example 1 except that 42 parts by mass of the water-soluble polyester resin of Reference Example 3 was used instead of 42 parts by mass of the solution of the condensation reaction product in isopropyl alcohol of Reference Example 2 in preparation of the composition for formation of an antistatic layer.

### Comparative Example 2

An antistatic release film was produced in the same manner as in Example 1 except that 1 part by mass of the water-soluble polyester resin of Reference Example 3 was not used in preparation of the composition for formation of an antistatic layer.

### Comparative Example 3

An antistatic release film was produced in the same manner as in Example 1 except that 42 parts by mass of the solution of the condensation reaction product in isopropyl alcohol of Reference Example 2 was not used in preparation of the composition for formation of an antistatic layer.

### Comparative Example 4

An antistatic release film was produced in the same manner as in Example 1 except that 42 parts by mass of the solution of the partial hydrolysate of methyl silicate having a number average molecular weight of 350 in isopropyl alcohol of Reference Example 1 was used instead of 42 parts by mass of the solution of the condensation reaction product in isopropyl alcohol of Reference Example 2 in preparation of the composition for formation of an antistatic layer.

### <<Evaluation>>

In the antistatic release film obtained in each of Examples 1 and 2 and Comparative Examples 1 to 4, an initial “release force,” an initial “residual adhesive force,” “surface resistivity,” and “adhesion force” before and after aging were evaluated as follows. The obtained results are shown in Table 1.

### (Initial Release Force)

An acrylic adhesive film (T4090, Dexerials Corporation) was stuck on a face of the silicone-based release layer of the antistatic release film at a temperature of 70° C. and a pressure of 25 g/cm², and after 16 hours, the release force was measured by a release testing machine (TENSILON universal material testing instrument, ORIENTEC Co., LTD). It is desirable that the release force be 2 N/5 cm or less in practical terms, and preferably 0.6 N/5 cm or less.

### (Initial Residual Adhesive Force)

The “release force” of an antistatic release film in a commercially available polyester adhesive tape (31B, Nitto Denko Corporation) was evaluated as described above. After that, the polyester adhesive tape face in contact with the silicone-based release layer was similarly stuck on a polyethylene terephthalate substrate film (Lumirror 510, Toray Industries, Inc.) that was not subjected to a release treatment. After 16 hours, the release strength was measured (release strength A). Further, a commercially available polyester adhesive tape (31B, Nitto Denko Corporation) of which the release force was not evaluated was similarly stuck on a Teflon (registered trademark) film. After 20 hours, the polyester adhesive tape was released, and the polyester adhesive tape face in contact with the Teflon (registered trademark) film was similarly stuck on a polyethylene terephthalate substrate film (Lumirror S10, Toray Industries, Inc.) that was not subjected to a release treatment. After 16 hours, the release strength was measured (release strength B). The release strength A and the release strength B are substituted into the following equation (1) to determine a residual adhesive force. The residual adhesive force is desirably 80% or more.

Residual adhesive force (%)={(A/B)×100} (1)

### (Surface Resistance)

The surface resistance [Ω/square] of a surface of the antistatic release film on a silicone-based release layer side was measured by a resistivity meter (Hiresta, Mitsubishi Chemical Analytech, Co., Ltd.). The surface resistivity is desirably 1×10¹¹Ω/square or more.

### (Adhesion Force)

Before and after an aging test in which the antistatic release film was left at 40° C. under an environment of a humidity of 95% for 1 month, a surface of the antistatic release film on a silicone-based release layer side was rubbed repeatedly 10 times with a finger. At this time, whether or not the released layer was separated was observed visually, and the adhesion force was evaluated in accordance with the following criteria.

### Rank Criteria

A: a case where occurrence of separation is not observed

B: a case where occurrence of separation between a substrate film and an antistatic layer is observed

C: a case where occurrence of separation between an antistatic layer and a release layer is observed

TABLE 1

| | EXAMPLE | | COMPARATIVE EXAMPLE | | | |
|---|---|---|---|---|---|---|
| | 1 | 2 | 1 | 2 | 3 | 4 |
| INITIAL RELEASE | 0.22 | 1.85 | 0.21 | 0.23 | 0.22 | 0.21 |
| FORCE (N/5 cm) | | | | | | |
| INITIAL RESIDUAL | 98 | 99 | 85 | 97 | 96 | 93 |
| ADHESIVE FORCE (%) | | | | | | |
| SURFACE | 3 × 10⁸ | 1 × 10⁸ | 2 × 10¹⁰ | 3 × 10⁹ | 3 × 10⁷ | 3 × 10⁸ |
| RESISTIVITY | | | | | | |
| (Ω/Square) | | | | | | |
| ADHESION | A | A | B | A | B | A |
| BEFORE AGING | | | | | | |
| ADHESION | A | A | B | C | B | B |
| AFTER AGING | | | | | | |

As shown in Table 1, in the antistatic release films of Examples 1 and 2, results of the initial release force, initial residual adhesive force, and surface resistivity were favorable, and the adhesion forces before and after aging were evaluated as A.

On the other hand, in the antistatic release film of Comparative Example 1, a large amount of water-soluble resin for film formation was used for an antistatic layer, but a condensation reaction product obtained by a condensation reaction of a hydrolysate of an alkyl silicate with a coupling agent was not used. Therefore, the initial residual adhesive force was very low and the surface resistivity was high as compared with Examples. The adhesions before and after aging were evaluated as B.

In the antistatic release film of Comparative Example 2, a condensation reaction product obtained by a condensation reaction of a hydrolysate of an alkyl silicate with a coupling agent was used for an antistatic layer, but a water-soluble resin for film formation was not used. Therefore, the adhesion before aging was evaluated as A, and the adhesion after aging was evaluated as C.

In the antistatic release film of Comparative Example 3, a small amount of water-soluble resin for film formation was used for an antistatic layer, but a condensation reaction product obtained by a condensation reaction of a hydrolysate of an alkyl silicate with a coupling agent was not used. Therefore, the surface resistivity was high as compared with Examples, and the adhesions before and after aging were evaluated as B.

In the antistatic release film of Comparative Example 4, a hydrolysate of an alkyl silicate was used for an antistatic layer, but a condensation reaction product obtained by a condensation reaction of a hydrolysate of an alkyl silicate with a coupling agent was not used. Therefore, the initial residual adhesive force was low as compared with Examples. The adhesion after aging is evaluated as B.

### INDUSTRIAL APPLICABILITY

In the antistatic release film of the present invention, the antistatic layer contains a condensation reaction product obtained by a condensation reaction of a hydrolysate of an alkyl silicate with a coupling agent. Therefore, the antistatic layer is allowed to secure favorable adhesion to a substrate film such as a polyester film, and also allowed to secure favorable adhesion to a silicone-based release layer, for example, even when the film is left under a high temperature and high humidity environment. Accordingly, it is useful as a release film of an anisotropic conductive film.

### REFERENCE SIGNS LIST

1 substrate film
2 antistatic layer
3 silicone-based release layer

1. An antistatic release film comprising an antistatic layer formed on one side of a substrate film, and a silicone-based release layer formed on the antistatic layer, wherein the antistatic layer contains the following components (a) to (c):
(a) a condensation reaction product obtained by a condensation reaction of a hydrolysate of an alkyl silicate with a coupling agent;
(b) a water-soluble resin for film formation; and
(c) an antistatic agent.

2. The antistatic release film according to claim 1, wherein the alkyl silicate is a compound represented by the formula (1), 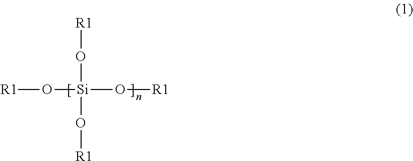
where, in the formula (1), R1 is an alkyl group, and n is an integer of 1 or more.

3. The antistatic release film according to claim 1, wherein the hydrolysate of the alkyl silicate has a number average molecular weight of 200 to 500.

4. The antistatic release film according to claim 2, wherein R1 is an alkyl group having 1 to 3 carbon atoms and n is an integer of 3 to 8.

5. The antistatic release film according to claim 4, wherein R1 is a methyl group and n is 5.

6. The antistatic release film according to claim 1, wherein a degree of hydrolysis of the alkyl silicate is such that 50% or more of total number of OR1 groups are hydrolyzed to become hydroxyl groups.

7. The antistatic release film according to claim 1, wherein the coupling agent is a compound represented by the formula (2), 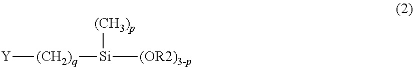
where, in the formula (2), R2 is an alkyl group that may be substituted with an alkoxy group or an acyloxy group, Y is a glycidyloxy group, an epoxy group, an amino group, a vinyl group, an allyl group, a (meth)acryloyloxy group, a mercapto group, an isocyanate group, an ureido group, or an alkylthio group having 1 to 3 carbon atoms, p is an integer of 0 to 2, and q is an integer of 0 to 3.

8. The antistatic release film according to claim 7, wherein R2 is a methyl group, Y is a glycidyloxy group, p is 0, and q is 3.

9. The antistatic release film according to claim 1, wherein the condensation reaction product is obtained by a condensation reaction of 100 parts by mass of the hydrolysate of the alkyl silicate with 200 to 300 parts by mass of the coupling agent.

10. The antistatic release film according to claim 1, wherein the water-soluble resin for film formation is a polyester resin at least 10 g of which is dissolved in 100 g of water at 20° C.

11. The antistatic release film according to claim 1, wherein the antistatic agent as the component (c) is a conductive macromolecule.

12. The antistatic release film according to claim 11, wherein the conductive macromolecule has a structure represented by the following formula (3) or (4), where, in the formula, m is the number of the repeating unit,

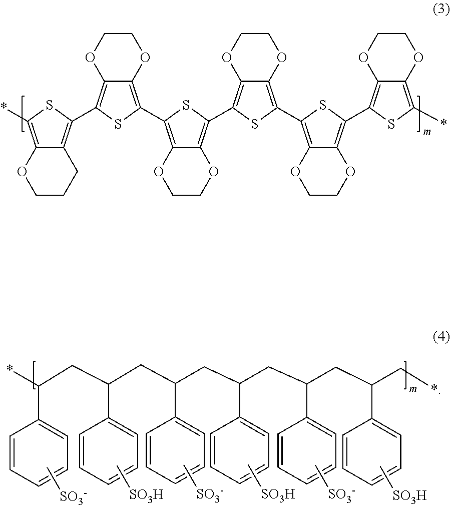

13. The antistatic release film according to claim 1, wherein the antistatic layer contains the condensation reaction product as the component (a) in an amount of 45 to 65% by mass, the water-soluble resin for film formation as the component (b) in an amount of 10 to 30% by mass, and the antistatic agent as the component (c) in an amount of 20 to 30% by mass, and a content ratio by mass of the component (a) to the component (b) is 100:200 to 300.

14. An adhesive tape with a release film obtained by layering a double-sided adhesive film on the antistatic release film according to claim 1.

15. The adhesive tape with a release film according to claim 14, wherein the double-sided adhesive film is an anisotropic conductive film.
